(19) United States
(12) Patent Application Publication
(10) Pub. No.: US 2025/0117546 A1
(43) Pub. Date: Apr. 10, 2025

(54) PREDICTION METHOD FOR CRITICAL VIBRATION SPEED OF SIX-HIGH COLD ROLLING MILL BASED ON THREE-DIMENSIONAL MODEL

(71) Applicant: Northeastern University, Shenyang City (CN)

(72) Inventors: Xu LI, Shenyang City (CN); Lei CAO, Shenyang City (CN); Xin ZHANG, Shenyang City (CN); Pengfei WANG, Shenyang City (CN); Shuzong CHEN, Shenyang City (CN); Dianhua ZHANG, Shenyang City (CN); Changchun HUA, Shenyang City (CN)

(21) Appl. No.: 18/016,285

(22) PCT Filed: Jun. 8, 2022
(86) PCT No.: PCT/CN2022/097497

§ 371 Date: Aug. 30, 2024

(30) Foreign Application Priority Data
Nov. 19, 2021 (CN) 202111392303.9

(51) Int. Cl. G06F 30/23; G06F 119/14

(52) U.S. Cl. CPC G06F 30/23; G06F 2119/14

(57) ABSTRACT

The invention provides a prediction method for critical vibration speed of a six-high cold rolling mill based on a three-dimensional model. The critical vibration speed is predicted based on a three-dimensional six-high cold rolling mill model, under the consideration that the rolls shall be considered as short and thick beams and influence of shear deformation needs to be considered, Timoshenko beams are selected, and besides, Hermite interpolation is used for node displacement vectors; a vertical vibration dynamic equation of the mill-strip system can be established by stress analysis among the strip, rolls and mill housing; solving is performed by the Newmark-Beta method, a displacement response curve of the rolls at a specific speed can be obtained, and if the amplitude of displacement response curve is constant, the speed is the critical vibration speed of the six-high rolling mill.

### FIELD OF THE INVENTION

The invention belongs to the technical field of rolling process automation, and particularly relates to a prediction method for critical vibration speed of a six-high cold rolling mill based on a three-dimensional model.

### THE PRIOR ARTS

During thin-gauge high-speed rolling, due to multi-variable, strong coupling and nonlinear characteristics of rolling parameters, equipment statuses and control systems, various abnormal vibrations that are difficult to eliminate by adjusting rolling parameters often occur in the rolling mill, which is a bottleneck problem restricting high speed and high precision of a rolling process. A key to ensure efficient and stable operation of the rolling process is rational formulation of rolling parameters. In the high-speed rolling process, when the rolling speed exceeds a certain critical value, severe self-excited vibration will occur in the rolling mill. Due to huge varieties, mutual coupling and strong nonlinear characteristics of the rolling parameters, critical vibration speeds under different rolling parameters often differ greatly. The root cause of vibration of the rolling mill lies in that the change of the rolling parameters reduces the equivalent damping of rolling interface, which leads to absorb energy continuously from the transmission device of mill-strip system and increase the amplitude of roll. Finally, instability of the rolling process occurs.

Researchers at home and abroad made a lot of relevant researches on such vibration problem of the rolling mill. The Chinese invention patent “Method for predicting ultimate rolling speed of six-high cold rolling mill” (patent No.: CN 109078989 A) provides a method for predicting ultimate rolling speed of a rolling mill. In the method, the relationship between actual equivalent damping coefficients and rolling speed is established, negative damping effect caused by back tention fluctuation of strip is calculated, and finally, the ultimate rolling speed of the rolling mill is obtained by using the relationship between the damping coefficients and the rolling speed. The Chinese invention patent “Technology method for prediction and suppression of self-excited vibration of high-speed thin plate rolling mill” (patent No.: CN 106734194 A) discloses a method for prediction and suppression of self-excited vibration based on the relationship between rolling speed and self-excited vibration induced conditions of the rolling mill. In the method, the plastic deformation of strip and asymmetry of upper and lower roll systems are firstly considered to establish a structure dynamic model of the rolling mill. And then, the analytical solution of rolling force is operated by integration and Taylor series expansion to obtain rolling force increment The critical rolling speed is solved by using ROUTH stability criterion. Finally, the self-excited vibration is predicted according to a stability margin of the rolling speed and abnormal change of forward slip value under different rolling parameters. Besides, the optimization measures are given. The Chinese invention patent “Method for vibration suppression of tandem cold rolling mill” (patent No.: CN 105522000 A) provides a method for vibration suppression of the rolling mill by controlling injection amount of emulsion. According to the method, whether the rolling mill vibrates is judged according to signal energy collected by a vibration sensor on the 4th stand or 5th stand, and then the injection amount of the emulsion at the entrance of the 4th stand or 5th stand is decided according to the vibration signal energy or the forward slip value. The Chinese journal article “Study on Overall Coupled Modeling of the Rolling Mill” (Journal of Mechanical Engineering, 2015, 51 (14): 46-53) analyzes the generation mechanism of different types of vibration and interrelationships, and further establishes a coupled vibration structure model of the rolling mill considering vertical-horizontal-torsional and horizontal flutter of strip. On this basis, the integrated coupling chatter kinetic model of the rolling mill is built. The foreign journal article “Dynamic analysis of cold-rolling process using the finite-element method” (Journal of Manufacturing Science and Engineering, 2016, 138 (4): 041002) provides a simplified model of a four-high rolling mill based on the finite element method. According to the method, rolls are equivalent to Euler-Bernoulli beams. Influence of the vibration of the rolling mill on the outlet profile, stress and rolling pressure distribution of the strip along width direction are studied, and the influence of strip width on vibration of the rolling mill is also analyzed.

The main disadvantage of the researches in the Chinese patents and journals lies in that components of the rolling mill are simplified as mass points, and the influence of parameters along width direction, such as rolls bending and shifting and strip width on the vibration of the rolling mill are ignored. However, the main disadvantage of the researches in foreign journals lies in that the rolls are simplified as Euler-Bernoulli beams, which ignores the shear deformation when the rolls vertically vibrate, and the influence of the vibration speed of the rolls is not considered during the calculation of rolling force, so that the model precision is not high.

### SUMMARY OF THE INVENTION

For the disadvantage existing in the prior art, the invention provides a prediction method for critical vibration speed of a six-high cold rolling mill based on a three-dimensional model. The method comprises the following steps:
Step 1: obtaining production process parameters in a period of time in an actual production of a cold continuous rolling production line.
Step 2: according to a finite element model and an inter-roll contact stiffness of each roll in the six-high cold rolling mill, establishing a whole stiffness, mass and damping matrixes of the six-high cold rolling mill.
Step 3: discretizing a deformation zone into a number of parts along the rolling and width directions, and calculating a dynamic rolling force.
Step 4: according to a force relationship between rolls and strip and the calculated dynamic rolling force, establishing a vertical vibration dynamic equation of a mill-strip system, and obtaining a roll displacement response to predict the critical vibration speed of the six-high cold rolling mill.

Production process parameters comprise the structure parameters of the six-high cold rolling mill, rolling parameters, strip parameters and lubricating oil parameters.

The structure parameters of the six-high cold rolling mill comprise material, elasticity modulus, Poisson's ratio and density of rolls, body length and diameter of rolls, neck length and diameter of rolls and material, mass and size of a mill housing.

The rolling parameters comprise front and back tensions between stands, rolling speed of each rolling pass, strip inlet speed of each rolling pass, strip inlet and outlet thicknesses of each rolling pass, work roll bending force, intermediate roll bending force and intermediate roll shifting value.

The strip and lubricating oil parameters comprise grade and width of strip, incoming material thickness, and viscosity and viscosity pressure coefficient of lubricating oil.

The Step 2 comprises the following steps:
Step 2.1: establishing the finite element model of each roll in the six-high cold rolling mill.
Step 2.2: calculating the inter-roll contact stiffness of each roll.
Step 2.3: according to the finite element model and the inter-roll contact stiffness of each roll, establishing a whole stiffness, mass and damping matrixes of the six-high cold rolling mill.

The Step 3 comprises the following steps:
Step 3.1: calculating the dynamic contact arc length l_{d} of deformation zone according to strip inlet and outlet thicknesses, a diameter and a vertical vibration speed of a work roll, by the following equation:

$${l}_{d} = \{ \begin{matrix}\sqrt{{( R sin θ )}^{2} + R cos θ ( {y}_{in} - {y}_{out} ) - \frac{{( {y}_{in} - {y}_{out} )}^{2}}{4}} - R sin θ & {v}_{y} \geq 0 \\ \sqrt{{( R sin θ )}^{2} + R cos θ ( {y}_{in} - {y}_{out} ) - \frac{{( {y}_{in} - {y}_{out} )}^{2}}{4}} + R sin θ & {v}_{y} < 0\end{matrix} .$$

Wherein R represents a flattening radius of the work roll; yᵢₙ and yₒᵤₜ represent the strip inlet and outlet thicknesses; θ represents a variation of a bite angle; and v_{y} represents the vertical vibration speed of the work roll and is positive in an upward direction.
Step 3.2: calculating the average deformation resistance of each micro element by using a deformation resistance model according to the strip material and thickness of each micro element.
Step 3.3: calculating friction stress distribution in the deformation zone.
Step 3.4: establishing the force balance differential equation of the micro element in the deformation zone.
Step 3.5: substituting the friction stress distribution obtained in the Step 3.3 into the force balance differential equation, and integrating the differential equation along the rolling and width directions to obtain the dynamic rolling force.

The Step 4 comprises the following steps:
Step 4.1: establishing vertical vibration dynamic equation of the mill-strip system according to the following equations:

$$M \ddot{x} + C \dot{x} + Kx = F - {F}_{iw} - {F}_{bi} , \\ M \ddot{x} + C \dot{x} + {K}_{z} x = M \ddot{x} + ( {β}_{1} M + {β}_{2} {K}_{z} ) \dot{x} + ( K + {K}_{iw} + {K}_{bi} ) x = F , \\ {β}_{1} = \frac{2 ( {ξ}_{1} {ω}_{2} - {ξ}_{2} {ω}_{1} )}{( {ω}_{2}^{2} - {ω}_{1}^{2} )} {ω}_{1} {ω}_{2} , {β}_{2} = \frac{2 ( {ξ}_{1} {ω}_{2} - {ξ}_{2} {ω}_{1} )}{( {ω}_{2}^{2} - {ω}_{1}^{2} )} .$$

Wherein x, \dot{x} and \ddot{x} respectively represent displacement, speed and acceleration vectors of beam element nodes of the rolls; M represents a whole mass matrix of the six-high cold rolling mill; C represents a whole damping matrix of the six-high cold rolling mill; K_{z} represents a whole stiffness matrix of the six-high cold rolling mill; K represents a total stiffness matrix formed by combining beam element models of a backup roll, an intermediate roll and a work roll; K_{iw} represents an inter-roll contact stiffness matrix between the intermediate roll and the work roll; K_{bi} represents an inter-roll contact stiffness matrix between the backup roll and the intermediate roll; F_{iw} represents a contact force distribution between the work roll and the intermediate roll, F_{iw}=K_{iw}x; F_{bi} represents a contact force distribution between the intermediate roll and the backup roll, F_{bi}=K_{bi}x; F represents rolling force distribution along width direction; β₁ and β₂ represent proportional coefficients; ξ₁ and ξ₂ represent damping ratios; ω₁ and ω₂ represent frequencies.
Step 4.2: solving the vertical vibration dynamic equation by the Newmark-Beta method to obtain a displacement response curve of the rolls at a specific speed, wherein when the amplitude of the displacement response curve is constant, a corresponding speed is the critical vibration speed of the six-high cold rolling mill.

The Step 2.1 comprises the following steps:
Step 2.1.1: simplifying each roll in the six-high cold rolling mill to beams and discretizing into a number of elements.
Step 2.1.2: determining a shape function expression of node displacement vectors of each element according to an interpolation function.
Step 2.1.3: deriving an element stiffness matrix by using a virtual work principle and performing assembling.
Step 2.1.4: deriving an element mass matrix by using the virtual work principle and performing assembling.

The Step 2.3 comprises the following steps:
Step 2.3.1: obtaining the stiffness coefficients of the six-high cold rolling mill by a pressing test, and calculating the stiffness coefficients of the mill housing by a finite element analysis software.
Step 2.3.2: determining stiffness coefficients of the backup roll in combination with the calculated inter-roll contact stiffness, and finally, obtaining the whole stiffness matrix of the six-high cold rolling mill, according to the following equation:

$${K}_{z} = K + {K}_{iw} + {K}_{bi} .$$

Wherein K_{z} represents the whole stiffness matrix of the six-high cold rolling mill; K represents a total stiffness matrix formed by combining beam element models of the backup roll, the intermediate roll and the work roll; K_{iw} represents the inter-roll contact stiffness matrix between the intermediate roll and the work roll; K_{bi} represents the inter-roll contact stiffness matrix between the backup roll and the work roll, according to the following equations:

$${K}_{iw} = {[ \begin{matrix}- {k}_{{n}_{1} {n}_{1}}^{1} & & {k}_{{n}_{1} {n}_{3}}^{1} & & & \\ & ⋱ & & ⋱ & & \\ & & - {k}_{{n}_{2} {n}_{2}}^{1} & & {k}_{{n}_{2} {n}_{4}}^{1} & \\ {k}_{{n}_{3} {n}_{1}}^{1} & & & - {k}_{{n}_{3} {n}_{3}}^{1} & & \\ & ⋱ & & & ⋱ & \\ & & {k}_{{n}_{4} {n}_{2}}^{1} & & & - {k}_{{n}_{4} {n}_{4}}^{1}\end{matrix} ]}_{2 n \times 2 n} ; \\ {K}_{bi} = {[ \begin{matrix}- {k}_{{n}_{3} {n}_{3}}^{2} & & {k}_{{n}_{3} {n}_{5}}^{2} & & & \\ & ⋱ & & ⋱ & & \\ & & - {k}_{{n}_{4} {n}_{4}}^{2} & & {k}_{{n}_{4} {n}_{6}}^{2} & \\ {k}_{{n}_{5} {n}_{3}}^{2} & & & - {k}_{{n}_{5} {n}_{5}}^{2} & & \\ & ⋱ & & & ⋱ & \\ & & {k}_{{n}_{6} {n}_{4}}^{2} & & & - {k}_{{n}_{6} {n}_{6}}^{2}\end{matrix} ]}_{2 n \times 2 n} .$$

Wherein n=n_{w}+nᵢ+n_{b}, n₁-n₆ represent row and column numbers, which are selected according to the following conditions:

$$\begin{matrix}{n}_{1} = 1 ; {n}_{2} = 2 {n}_{w} - 1 ; {n}_{3} = 2 {n}_{w} + 1 ; {n}_{4} = 2 ( {n}_{w} + {n}_{i} ) - 1 \\ {n}_{5} = 2 ( {n}_{w} + {n}_{i} ) + 1 ; {n}_{6} = 2 ( {n}_{w} + {n}_{i} + {n}_{b} ) - 1\end{matrix} , if {n}_{s} = 0 , \\ \begin{matrix}{n}_{1} = 2 {n}_{s} + 1 ; {n}_{2} = 2 {n}_{w} - 1 ; {n}_{3} = 2 {n}_{w} + 1 ; {n}_{4} = 2 ( {n}_{w} + {n}_{i} - {n}_{s} ) - 1 \\ {n}_{5} = 2 ( {n}_{w} + {n}_{i} + {n}_{s} ) + 1 ; {n}_{6} = 2 ( {n}_{w} + {n}_{i} + {n}_{b} ) - 1\end{matrix} , \\ if {n}_{s} > 0 , \\ \begin{matrix}{n}_{1} = 1 ; {n}_{2} = 2 ( {n}_{w} - {n}_{s} ) - 1 ; {n}_{3} = 2 ( {n}_{w} + {n}_{s} ) + 1 ; {n}_{4} = 2 ( {n}_{w} + {n}_{i} ) - 1 \\ {n}_{5} = 2 ( {n}_{w} + {n}_{i} ) + 1 ; {n}_{6} = 2 ( {n}_{w} + {n}_{i} + {n}_{b} - {n}_{s} ) - 1\end{matrix} , \\ if {n}_{s} < 0.$$

Wherein n_{w}, nᵢ and n_{b} respectively represent the number of nodes of the work roll, the intermediate roll and the backup roll; nₛ represents the number of the nodes corresponding to the shifting value of the intermediate roll.
Step 2.3.3: by using a Rayleigh damping formula, the whole stiffness and mass matrixes of the six-high cold rolling mill, obtaining the whole damping matrix of the six-high cold rolling mill.

The prediction method has the beneficial effects.

The invention provides the prediction method for critical vibration speed of a six-high cold rolling mill based on a three-dimensional model, the critical vibration speed is predicted based on a three-dimensional six-high cold rolling mill model, under the consideration that the rolls shall be considered as short and thick beams and influence of shear deformation needs to be considered, Timoshenko beams are selected, and besides, Hermite interpolation is used for node displacement vectors; a vertical vibration dynamic equation of the mill-strip system can be established by stress analysis among the strip, rolls and mill housing; solving by the Newmark-Beta method, a displacement response curve of the rolls at a specific speed can be obtained, and if the amplitude of the displacement response curve is constant, the speed is the critical vibration speed of the six-high cold rolling mill; according to the prediction method for critical vibration speed of the six-high cold rolling mill based on a three-dimensional model provided by the invention, firstly, a three-dimensional six-high cold rolling mill model is constructed with improved Timoshenko beams by coupling a dynamic rolling force calculation model, calculation speed and precision are improved; secondly, by the method, not only influence of two-dimensional rolling parameters on the stability of the rolling process can be studied, but also influence of parameters along width direction, such as roll bending and shifting, on the critical rolling speed can be analyzed, and compared with other methods, using the method disclosed by the invention, the analysis parameters are more comprehensive and reasonable; and furthermore, by adopting the method provided by the invention, the critical vibration speed of the six-high cold rolling mill can be predicted at the rolling schedule formulation stage, thereby providing theoretical support for the optimization of rolling parameters.

### BRIEF DESCRIPTION OF DRAWINGS

FIG. 1 shows a flow chart of a prediction method for critical vibration speed of a six-high cold rolling mill based on a three-dimensional model, disclosed by the invention.

FIG. 2 shows a schematic diagram of a simplified model of an upper roll system of the six-high cold rolling mill in the invention.

FIG. 3 shows a schematic diagram of Timoshenko beam elements in the invention.

FIG. 4 shows a schematic diagram of inter-roll contact stiffness calculation in the invention.

FIG. 5 shows a schematic diagram of grid division of a three-dimensional deformation zone in the invention.

FIG. 6 shows an influence diagram of work roll bending force on the critical rolling speed and corresponding strip outlet profile in the invention, wherein (a) is the influence diagram of work roll bending force on the critical rolling speed of the six-high cold rolling mill, and (b) is the strip outlet profile at the corresponding critical vibration speed.

FIG. 7 shows an influence diagram of intermediate roll shifting value on the critical rolling speed and corresponding strip outlet profile in the invention, wherein (a) is the influence diagram of intermediate roll shifting value on the critical rolling speed of the six-high cold rolling mill, and (b) is the strip outlet profile at the corresponding critical vibration speed.

FIG. 8 shows an influence diagram of intermediate roll bending force on the critical rolling speed and corresponding strip outlet profile in the invention, wherein (a) is the influence diagram of intermediate roll bending force on the critical rolling speed of the six-high cold rolling mill, and (b) is the strip outlet profile at the corresponding critical vibration speed.

### DETAILED DESCRIPTION OF THE PREFERRED EMBODIMENT

The invention is further described in detail below in combination with the drawings and specific embodiments. The invention aims to provide a prediction method for critical vibration speed of a six-high cold rolling mill based on a three-dimensional model. An improved Timoshenko beam is used, influence of parameters along width direction, such as roll bending and shifting, on the critical rolling speed can be analyzed by a few elements, a basis is provided for formulating more accurate and reasonable rolling procedures, and the self-excited vibration of the six-high cold rolling mill caused by excessive rolling speed or unreasonable setting of rolling parameters can be avoided, so as to achieve the purpose of efficient and stable operation of a tandem cold rolling mill.

In the embodiments, a 1450 mm UCM six-high tandem cold rolling mill of a factory is taken as an example to predict critical vibration speed under different parameters of the roll bending and shifting. The backup roll, the intermediate roll and the work roll are flat rolls.

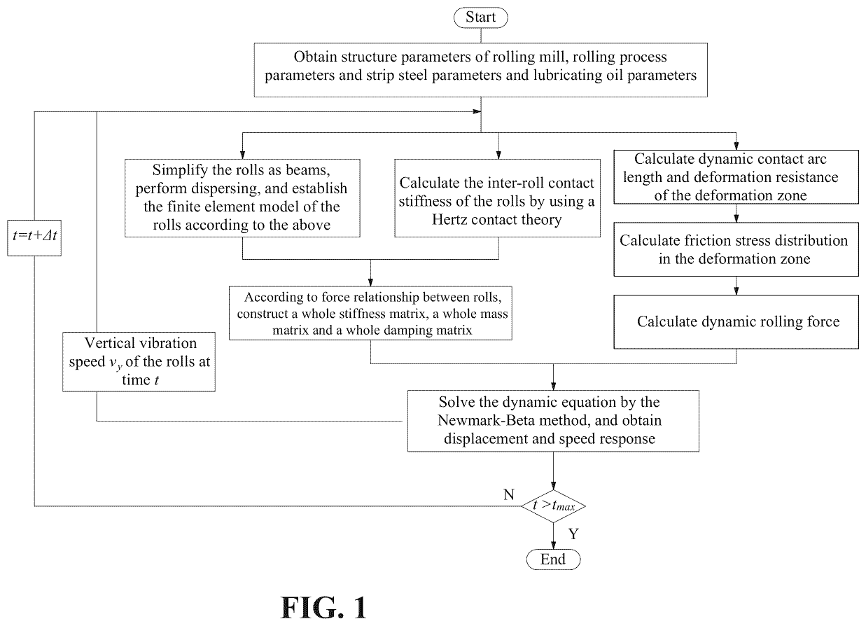

As shown in FIG. 1, a prediction method for critical vibration speed of a six-high cold rolling mill based on a three-dimensional model comprises the following steps:
Step 1: production process parameters in a period of time in an actual production of a tandem cold rolling production line are obtained; production process parameters comprise rolling mill structure, rolling, strip and lubricating oil parameters.

The structure parameters of the six-high cold rolling mill comprise the material, elasticity modulus, Poisson's ratio and density of rolls, the body length and diameter of rolls, the neck length and diameter of rolls and the material, mass and size of mill housing. The required parameters can be obtained according to the design drawings of the rolls.

The rolling parameters comprise front and back tensions between stands, rolling speed of each rolling pass, strip inlet speed of each rolling pass, strip inlet and outlet thicknesses of each rolling pass, work roll bending force, intermediate roll bending force and intermediate roll shifting value. The required parameters can be obtained from the primary and secondary control system of the tandem cold rolling production line.

The strip and lubricating oil parameters comprise grade and width of strip, incoming material thickness, and viscosity and viscosity pressure coefficient of lubricating oil. The strip parameters can be obtained from the primary and secondary control system of the tandem cold rolling production line, and the lubricating oil parameters can be determined by experiments.

In the embodiment, the structure parameters of the six-high cold rolling mill are shown as Table 1:

TABLE 1
Structure parameters of the six-high cold rolling mill

| Parameter name | Value | Parameter name | Value |
|---|---|---|---|
| elasticity modulus of work roll(Pa) | 2.1 × 10¹¹ | elasticity modulus of | 2.1 × 10¹¹ |
| | | intermediate roll (Pa) | |
| Poisson's ratio of work roll | 0.3 | Poisson's ratio of | 0.3 |
| | | intermediate roll | |
| density of work roll(kg/m3) | 7850 | density of intermediate | 7850 |
| | | roll(kg/m³) | |
| work roll body length (mm) | 1420 | intermediate roll body length | 1410 |
| | | (mm) | |
| work roll body diameter (mm) | 425 | intermediate roll body | 490 |
| | | diameter (mm) | |
| work roll neck length (mm) | 248 | vice intermediate roll length | 430 |
| | | (mm) | |
| work roll neck diameter (mm) | 240 | vice intermediate roll | 480 |
| | | diameter (mm) | |
| elasticity modulus of backup roll | 2.1 × 10¹¹ | intermediate roll neck length | 288 |
| (Pa) | | (mm) | |
| Poisson's ratio of backup roll | 0.3 | intermediate roll neck | 280 |
| | | diameter (mm) | |
| density of backup roll(kg/m³) | 7850 | | |
| backup roll body length (mm) | 1420 | | |
| backup roll body diameter (mm) | 1300 | | |
| backup roll neck length (mm) | 780 | | |
| backup roll neck diameter (mm) | 780 | | |

In the embodiment, the rolling technology parameters are shown as Table 2:

TABLE 2
Rolling technology parameters

| | First | Second | Third | Fourth | Fifth |
|---|---|---|---|---|---|
| Parameter name | stand | stand | stand | stand | stand |
| inlet thickness yᵢₙ (mm) | 2.909 | 1.882 | 1.091 | 0.660 | 0.448 |
| outlet thickness yₒᵤₜ (mm) | 1.882 | 1.091 | 0.660 | 0.448 | 0.330 |
| rolling speed vᵣ (m/s) | 3.87 | 6.92 | 11.38 | 16.60 | 22.50 |
| strip inlet speed Vᵢₙ (m/s) | 2.43 | 3.95 | 6.93 | 11.45 | 16.88 |
| back tension σ_{b} (MPa) | 54.58 | 128.10 | 128.32 | 142.42 | 142.86 |
| front tension σ_{f} (MPa) | 128.10 | 128.32 | 142.42 | 142.86 | 48.48 |
| comprehensive surface | 0.68 | 0.71 | 0.86 | 1.05 | 2.34 |
| roughness R_{q} (μm) | | | | | |
| work roll bending force (kN) | 499.8 | 627.2 | 50.8 | 450.8 | 392.0 |
| intermediate roll bending force | 284.2 | 186.2 | 176.4 | 196.0 | 529.2 |
| (kN) | | | | | |
| intermediate roll shifting value | 20 | 20 | 20 | 20 | 20 |
| (mm) | | | | | |

In the embodiment, the strip steel parameters and the lubricating oil parameters are shown as Table 3:

TABLE 3
Strip and lubricating oil parameters

| Parameter name | Value | Parameter name | Value |
|---|---|---|---|
| strip grade | Q195 | viscosity of lubricating oil under | 0.0344 |
| | | atmospheric pressure, η₀ (Pa · s) | |
| strip thickness W | 1000 | viscosity pressure coefficient of Barus | 0.0164 |
| (mm) | | formula, α (MPa⁻¹) | |
| hot-rolled incoming | 2.909 | viscosity pressure coefficient of | 0.5118 |
| material thickness y₀ | | Roelands formula, z | |
| (mm) | | | |

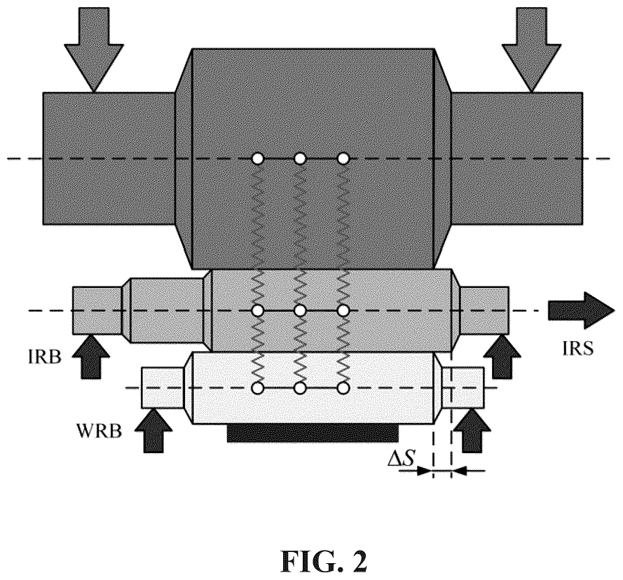

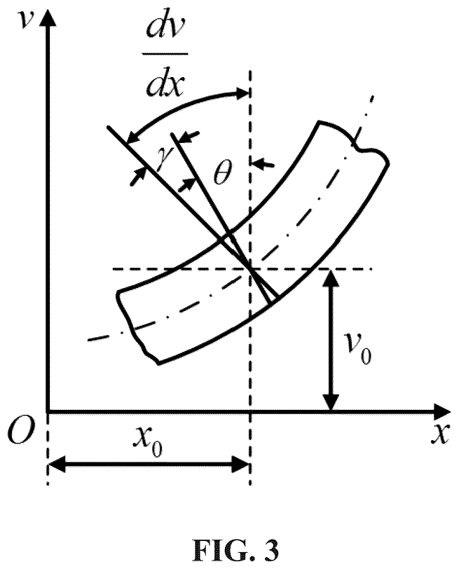

Step 2: according to the finite element model of each roll in the six-high cold rolling mill and inter-roll contact stiffness, the whole stiffness, mass and damping matrixes of the six-high cold rolling mill are established, wherein the Step 2 comprises the following steps:
Step 2.1: the finite element model of each roll in the six-high cold rolling mill is established, as shown in FIG. 2, WRB represents the work roll bending force, IRB represents the intermediate roll bending force, IRS represents the intermediate roll shifting, and AS represents the shifting value; firstly, the rolls are simplified as beams and discretized into a number of elements; then, according to the roll parameters, the finite element model of each roll is established, and the stiffness and mass matrixes are assembled, the Step 2.1 comprises the following steps:
Step 2.1.1: each roll in the six-high cold rolling mill is simplified to beams and discretized into a number of elements, wherein each element of the roll body is used as 5 mm and the roll neck is equally divided into 10 parts.
Step 2.1.2: a shape function expression of node displacement vectors of each element is determined according to an interpolation function; the displacement vector and the interpolation function of the beam elements are determined, the shape function expression is derived, under the consideration that the rolls shall be considered as short and thick beams and the influence of shear deformation needs to be considered, Timoshenko beams are selected, and since only vertical deformation of the rolls needs to be considered in the study, the displacement vectors of the node elements only include the vertical displacement and the corresponding rotation angle. As shown in FIG. 3, the node displacement vectors of the beam elements are expressed as:

$${δ}^{e} = {[ \begin{matrix}{v}_{1} & {θ}_{1} & {v}_{2} & {θ}_{2}\end{matrix} ]}^{T} .$$

Wherein δ^{e} represents the node displacement vector; v₁ represents the vertical displacement of the node 1; θ₁ represents the rotation angle of the node 1; v₂ represents the vertical displacement of the node 2; θ₂ represents the rotation angle of the node 2.

In order to improve calculation accuracy, Hermite interpolation is used for the node displacement vector:

$$v ( x ) = {a}_{0} + {a}_{1} x + {a}_{2} {x}^{2} + {a}_{3} {x}^{3} , \\ θ ( x ) = {a}_{1} + 2 {a}_{2} x + 3 {a}_{3} {x}^{2} - γ .$$

Wherein a₀ [symbol] a₁ [symbol] a₂ [symbol] a₃ represent undetermined coefficients.

From the mechanical relationship of materials, it can be obtained that:

$$\frac{dM}{dx} - Q = 0 ; M = - EI \frac{\partial θ}{\partial x} ; Q = ϕ GS γ .$$

Wherein M represents the bending moment; Q represents the shear force; E represents the elasticity modulus of rolls; I represents the sectional inertia moment of rolls; G represents the shear modulus of rolls; S represents the sectional area; γ represents the shear strain; ϕ represents the correction factor introduced to consider that the actual shear strain and stress are not uniformly distributed.

Therefore, it can be obtained that:

$$γ = - 6 ( \frac{EI}{ϕ GS} ) {a}_{3} = - 6 Λ {a}_{3} , Λ = \frac{EI}{ϕ GS} .$$

The expression of θ(x) can be simplified as:

$$θ ( x ) = {a}_{1} + 2 {a}_{2} x + ( 3 {x}^{2} + 6 Λ ) {a}_{3} .$$

Boundary conditions v₁=v(0), θ₁=θ(0), v₂=v(l) and θ₂=θ(l) are substituted into the expression of the node displacement vector to obtain the shape function expression of the node displacement vector:

$$v ( x ) = {N}_{{v}_{1}} {v}_{1} + {N}_{{v}_{2}} {θ}_{1} + {N}_{{v}_{3}} {v}_{2} + {N}_{{v}_{4}} {θ}_{2} , \{ \begin{matrix}{N}_{{v}_{1}} & = \overline{φ} ( 1 - 3 {ξ}^{2} + 2 {ξ}^{3} + φ ( 1 - ξ ) ) \\ {N}_{{v}_{2}} & = l \overline{φ} ( ξ - 2 {ξ}^{2} + {ξ}^{3} + \frac{φ}{2} ( ξ - {ξ}^{2} ) ) \\ {N}_{{v}_{3}} & = \overline{φ} ( 3 {ξ}^{2} - 2 {ξ}^{3} + φξ ) \\ {N}_{{v}_{4}} & = l \overline{φ} ( - {ξ}^{2} + {ξ}^{3} + \frac{φ}{2} ( - ξ + {ξ}^{2} ) )\end{matrix} ,$$

$$θ ( x ) = {N}_{{θ}_{1}} {v}_{1} + {N}_{{θ}_{2}} {θ}_{1} + {N}_{{θ}_{3}} {v}_{2} + {N}_{{θ}_{4}} {θ}_{2} , \{ \begin{matrix}{N}_{{θ}_{1}} & = \frac{6 \overline{φ}}{l} ( - ξ + {ξ}^{2} ) \\ {N}_{{θ}_{2}} & = \overline{φ} ( 1 - 4 ξ + 3 {ξ}^{2} + φ ( 1 - ξ ) ) \\ {N}_{{θ}_{3}} & = - \frac{6 \overline{φ}}{l} ( - ξ + {ξ}^{2} ) \\ {N}_{{θ}_{4}} & = \overline{φ} ( - 2 ξ + 3 {ξ}^{2} + φξ )\end{matrix} ,$$

$$\overline{φ} = \frac{1}{( 1 + φ )} ; φ = \frac{12 Λ}{{l}^{2}} = \frac{12 EI}{ϕ {GSl}^{2}} ; ξ = \frac{x}{l} .$$

Wherein Nᵥ_{ᵢ} (i=1,2,3,4) represents the shape function of vertical displacements; N_{θ}_{ᵢ} (i=1,2,3,4) represents the shape function of rotation angles; l represents the length of each beam element.
Step 2.1.3: an element stiffness matrix is derived by using a virtual work principle and assembling is performed.

According to the virtual work principle, the strain energy U^{e} of the elements consists of bending strain energy U_{b} and shear strain energy Uₛ, and the expression is as follows:

$${U}^{e} = {U}_{b}^{e} + {U}_{s}^{e} = \frac{1}{2} {\int }_{0}^{l} {( \frac{d θ}{dx} )}^{T} EI ( \frac{d θ}{dx} ) dx + \frac{1}{2} {\int }_{0}^{l} {( - θ + \frac{dv}{dx} )}^{T} \frac{G S}{ϕ} ( - θ + \frac{dv}{dx} ) dx , {K}^{e} = {K}_{b}^{e} + {K}_{s}^{e} = {\int }_{0}^{l} {N}_{b}^{T} {EIN}_{b} dx + {\int }_{0}^{l} {N}_{S}^{T} \frac{G S}{ϕ} {N}_{s} dx$$

$$Wherein ,$$

$${N}_{b} = [ {N}_{{θ}_{1}}^{′} {N}_{{θ}_{2}}^{′} {N}_{{θ}_{3}}^{′} {N}_{{θ}_{4}}^{′} ] , {N}_{s} = [ {N}_{{ν}_{1}} - {N}_{{θ}_{1}}^{′} {N}_{{ν}_{2}} - {N}_{{θ}_{2}}^{′} {N}_{{ν}_{3}} - {N}_{{θ}_{3}}^{′} {N}_{{ν}_{4}} - {N}_{{θ}_{4}}^{′} ] , {K}^{e} = {K}_{b}^{e} + {K}_{s}^{e} = \frac{EI \overline{φ}}{{l}^{3}} [ \begin{matrix}12 & 6 l & - 12 & 6 l \\ 6 l & ( 4 + ϕ ) {l}^{2} & - 6 l & ( 2 - ϕ ) {l}^{2} \\ - 12 & - 6 l & 12 & - 6 l \\ 6 l & ( 2 - ϕ ) {l}^{2} & - 6 l & ( 4 + ϕ ) {l}^{2}\end{matrix} ]$$

Wherein K_{b}^{e} and Kₛ^{e} respectively represent the bending and shear stiffness matrixes of the elements.
Step 2.1.4: an element mass matrix is derived by using the virtual work principle and assembling is performed.

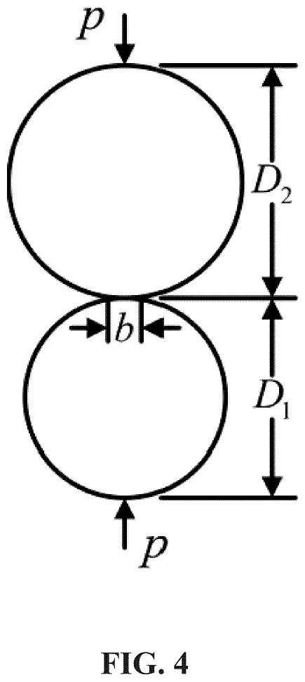

According to the virtual work principle, the kinetic energy T^{e} of the elements consists of translational kinetic energy Tₜ and rotation kinetic energy Tᵣ, and the expression is as follows:

$${T}^{e} = {T}_{t}^{e} + {T}_{r}^{e} = \frac{1}{2} {\int }_{0}^{l} {\dot{v}}^{T} ρ S \dot{v} dx + \frac{1}{2} {\int }_{0}^{l} {\dot{θ}}^{T} ρ I \dot{θ} dx ,$$

$${M}^{e} = {M}_{t}^{e} + {M}_{r}^{e} = {\int }_{0}^{l} {N}_{t}^{T} ρ {SN}_{t} dx + {\int }_{0}^{l} {N}_{r}^{T} ρ {IN}_{r} dx .$$

$$Wherein , {N}_{t} = [ {N}_{{ν}_{1}} {N}_{{ν}_{2}} {N}_{{ν}_{3}} {N}_{{ν}_{4}} ] ; {N}_{r} = [ {N}_{{θ}_{1}} {N}_{{θ}_{2}} {N}_{{θ}_{3}} {N}_{{θ}_{4}} ] ,$$

$${M}^{e} = \frac{ρ S {\overline{φ}}^{2}}{840} [ \begin{matrix}4 ( 78 + 147 φ + 70 {φ}^{2} ) & ( 44 + 77 φ + 35 {φ}^{2} ) l & 4 ( 27 + 63 φ + 35 {φ}^{2} ) & ( - 26 - 63 φ - 35 {φ}^{2} ) l \\ ( 44 + 77 φ + 35 {φ}^{2} ) l & ( 8 + 14 φ + 7 {φ}^{2} ) {l}^{2} & ( 26 + 63 φ + 35 {φ}^{2} ) l & ( - 6 - 14 φ - 7 {φ}^{2} ) {l}^{2} \\ 4 ( 27 + 63 φ + 35 {φ}^{2} ) & ( 26 + 63 φ + 35 {φ}^{2} ) l & 4 ( 78 + 147 φ + 70 {φ}^{2} ) & ( - 44 - 77 φ - 35 {φ}^{2} ) l \\ ( 26 - 63 φ - 35 {φ}^{2} ) l & ( - 6 - 14 φ - 7 {φ}^{2} ) {l}^{2} & ( - 44 - 77 φ - 35 {φ}^{2} ) l & ( 8 + 14 φ + 7 φ ) {l}^{2}\end{matrix} ] + \frac{ρ I {\overline{φ}}^{2}}{30} [ \begin{matrix}36 & ( 3 - 15 φ ) l & - 36 & ( 3 - 15 φ ) l \\ ( 3 - 15 φ ) l & ( 4 + 5 φ + 10 {φ}^{2} ) {l}^{2} & - ( 3 - 15 φ ) l & ( 5 {φ}^{2} - 5 φ - 1 ) {l}^{2} \\ - 36 & - ( 3 - 15 φ ) l & 36 & - ( 3 - 15 φ ) l \\ ( 3 - 15 φ ) l & ( 5 {φ}^{2} - 5 φ - 1 ) {l}^{2} & - ( 3 - 15 φ ) l & ( 4 + 5 φ + 10 {φ}^{2} ) {l}^{2}\end{matrix} ] .$$

Wherein M^{e}ₜ and M^{e}ᵣ respectively represent the translational and rotation mass matrixes of the elements; ρ represents the density of rolls; I represents the sectional inertia moment of rolls; S represents the sectional area.
Step 2.2: the inter-roll contact stiffness of each roll is calculated, as shown in FIG. 4.

According to the Hertz contact theory, the variation d_{c} of center distance between two rolls during compression is:

$${d}_{c} = \frac{2 p ( 1 - {v}^{2} )}{π E} ( \frac{2}{3} + ln \frac{2 {D}_{1}}{b} + ln \frac{2 {D}_{2}}{b} ) ,$$

$$b = 1. 60 \sqrt{{pK}_{D} {C}_{E}} , {K}_{D} = \frac{{D}_{1} {D}_{2}}{{D}_{1} + {D}_{2}} , {C}_{E} = 2 \frac{1 - {v}^{2}}{E} .$$

After sorting out, the following formula can be obtained:

$${d}_{c} = \frac{2 p ( 1 - {ν}^{2} )}{π E} ( \frac{2}{3} + ln ( \frac{0.7 \; 8125 E ( {D}_{1} + {D}_{2} )}{{p}_{i} ( 1 - {ν}^{2} )} ) ) .$$

p is derived at the same time from two sides:

$$\frac{{dd}_{c}}{dp} = \frac{2 ( 1 - {ν}^{2} )}{π E} ( \frac{- 1}{3} + ln ( \frac{0.7 \; 8125 E ( {D}_{1} + {D}_{2} )}{p ( 1 - {ν}^{2} )} ) ) .$$

Then, the inter-roll stiffness coefficients k_{i,j}^{1,2} of the rolls with unit lengths can be expressed as below:

$${k}_{i , j}^{1 , 2} = \frac{dp}{{dd}_{c}} = π E / 2 ( 1 - {ν}^{2} ) ( - \frac{1}{3} + ln ( \frac{0.7 \; 8125 E ( {D}_{1} + {D}_{2} )}{p ( 1 - {ν}^{2} )} ) ) .$$

Wherein 1 and 2 in k_{i,j}^{1,2} respectively refer to inter-roll contact stiffness coefficients between the work roll and the intermediate roll and the inter-roll contact stiffness coefficients between the backup roll and the intermediate roll, and i and j represent row and column numbers; p represents the rolling force of unit length; E represents the elasticity modulus of rolls; v represents the Poisson's ratio of rolls; and D₁ and D₂ represent diameters of two rolls.
Step 2.3: according to the finite element model and the inter-roll contact stiffness of each roll, the whole stiffness, mass and damping matrixes of the six-high cold rolling mill are established, wherein the Step 2.3 comprises the following steps.
Step 2.3.1: the stiffness coefficients of the six-high cold rolling mill are obtained by a pressing test, and the stiffness coefficients of mill housing are calculated by a finite element analysis software.
Step 2.3.2: the stiffness coefficients of the backup roll are determined in combination with the calculated inter-roll contact stiffness, and finally, the whole stiffness matrix of the six-high cold rolling mill is obtained.

In the embodiment, firstly, through pressing test on a 1450 mm UCM cold rolling mill, the total stiffness coefficients K=4.4×10⁹ N/m of the six-high cold rolling mill are obtained; then, the finite element analysis software is used to model the mill housing and solve the stiffness coefficients Kₛ=4.1×10¹⁰ N/m perpendicular to the rolling direction.

After determining the total stiffness of the six-high cold rolling mill and the stiffness coefficients of mill housing, the stiffness coefficients K_{b} of the backup roll can be calculated according to Hook's law:

$$\frac{1}{K} = 2 \times ( \frac{1}{{K}_{w}} + \frac{1}{{K}_{im}} + \frac{1}{{K}_{b}} + \frac{1}{{K}_{s}} ) .$$

Wherein K_{w} and Kᵢₘ are stiffness coefficients of the work roll and the intermediate roll respectively, which can be obtained by summing up along the roll body direction in the Step 2.2.

The whole stiffness matrix K_{z} of the six-high cold rolling mill can be seen from the force of the six-high cold rolling mill, according to the following equation:

$${K}_{𝓏} = K + {K}_{iw} + {K}_{bi} .$$

Wherein K represents the total stiffness matrix formed by combining beam element models of the backup roll, the intermediate roll and the work roll; K_{iw} represents the inter-roll contact stiffness matrix between the intermediate roll and the work roll; K_{bi} represents the inter-roll contact stiffness matrix between the backup roll and the intermediate roll, according to the following equations:

$${K}_{iw} = {[ \begin{matrix}- {k}_{{n}_{1} {n}_{1}}^{1} & & & {k}_{{n}_{1} {n}_{3}}^{1} & & \\ & ⋱ & & & ⋱ & \\ & & - {k}_{{n}_{2} {n}_{2}}^{1} & & & {k}_{{n}_{2} {n}_{4}}^{1} \\ {k}_{{n}_{3} {n}_{1}}^{1} & & & - {k}_{{n}_{3} {n}_{3}}^{1} & & \\ & ⋱ & & & ⋱ & \\ & & {k}_{{n}_{4} {n}_{2}}^{1} & & & - {k}_{{n}_{4} {n}_{4}}^{1}\end{matrix} ]}_{2 n \times 2 n} ; {K}_{bi} = {[ \begin{matrix}- {k}_{{n}_{3} {n}_{3}}^{2} & & & {k}_{{n}_{3} {n}_{5}}^{2} & & \\ & ⋱ & & & ⋱ & \\ & & - {k}_{{n}_{4} {n}_{4}}^{2} & & & {k}_{{n}_{4} {n}_{6}}^{2} \\ {k}_{{n}_{5} {n}_{3}}^{2} & & & - {k}_{{n}_{5} {n}_{5}}^{2} & & \\ & ⋱ & & & ⋱ & \\ & & {k}_{{n}_{6} {n}_{4}}^{2} & & & - {k}_{{n}_{6} {n}_{6}}^{2}\end{matrix} ]}_{2 n \times 2 n} .$$

Wherein n=n_{w}+nᵢ+n_{b}; n₁-n₆ represent row and column numbers, and are selected according to the following conditions:

$$\begin{matrix}{n}_{1} = 1 ; {n}_{2} = 2 {n}_{w} - 1 ; {n}_{3} = 2 {n}_{w} + 1 ; {n}_{4} = 2 ( {n}_{w} + {n}_{i} ) - 1 \\ {n}_{5} = 2 ( {n}_{w} + {n}_{i} ) + 1 ; {n}_{6} = 2 ( {n}_{w} + {n}_{i} + {n}_{b} ) - 1\end{matrix} , if {n}_{s} = 0 ,$$

$$\begin{matrix}{n}_{1} = 2 {n}_{s} + 1 ; {n}_{2} = 2 {n}_{w} - 1 ; {n}_{3} = 2 {n}_{w} + 1 ; {n}_{4} = 2 ( {n}_{w} + {n}_{i} - {n}_{s} ) - 1 \\ {n}_{5} = 2 ( {n}_{w} + {n}_{i} + {n}_{s} ) + 1 ; {n}_{6} = 2 ( {n}_{w} + {n}_{i} + {n}_{b} ) - 1\end{matrix} , if {n}_{s} > 0 ,$$

$$\begin{matrix}{n}_{1} = 1 ; {n}_{2} = 2 ( {n}_{w} - {n}_{s} ) - 1 ; {n}_{3} = 2 ( {n}_{w} + {n}_{s} ) + 1 ; {n}_{4} = 2 ( {n}_{w} + {n}_{i} ) - 1 \\ {n}_{5} = 2 ( {n}_{w} + {n}_{i} ) + 1 ; {n}_{6} = 2 ( {n}_{w} + {n}_{i} + {n}_{b} - {n}_{s} ) - 1\end{matrix} , if {n}_{s} < 0.$$

Wherein n_{w}, nᵢ and n_{b} respectively represent the number of nodes of the work roll, the intermediate roll and the backup roll; nₛ represents the number of the nodes corresponding to the intermediate roll shifting value.
Step 2.3.3: the whole mass matrix of the six-high cold rolling mill is obtained, and by using the Rayleigh damping formula, the whole stiffness and mass matrixes of the six-high cold rolling mill, the whole damping matrix of the six-high cold rolling mill is obtained.

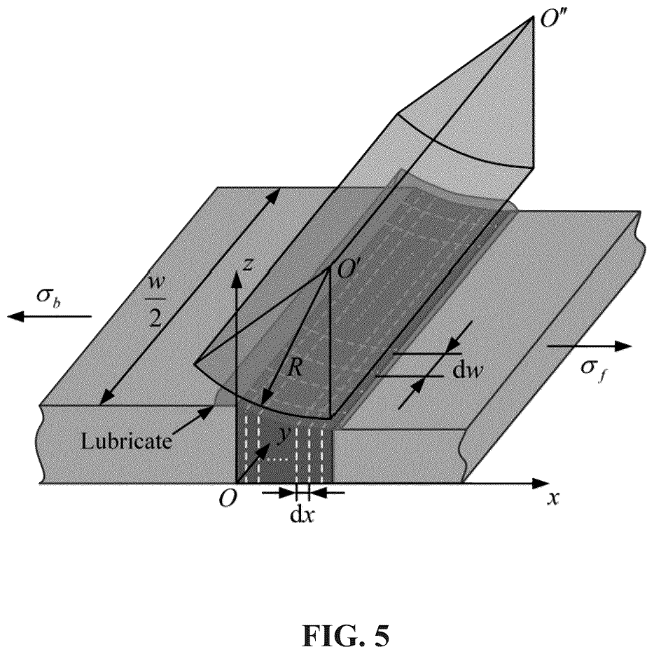

According to a construction method of Rayleigh damping, it is assumed that the damping matrix C of the structure is linear combination of the mass matrix M and the stiffness matrix K_{z}, namely:

$$C = {β}_{1} M + {β}_{2} {K}_{𝓏} ,$$

$${β}_{1} = \frac{2 ( {ξ}_{1} {ω}_{2} - {ξ}_{2} {ω}_{1} )}{( {ω}_{2}^{2} - {ω}_{1}^{2} )} {ω}_{1} {ω}_{2} , {β}_{2} = \frac{2 ( {ξ}_{1} {ω}_{2} - {ξ}_{2} {ω}_{1} )}{( {ω}_{2}^{2} - {ω}_{1}^{2} )} .$$

Wherein M represents the whole mass matrix formed by combining beam element models of the backup roll, the intermediate roll and the work roll; ω₁ and ω₂ represent frequencies, taking 100 Hz and 500 Hz respectively; and ξ₁ and ξ₂ represent the damping ratios, taking 0.03.
Step 3: the deformation zone is discretized into a number of elements along the rolling and width directions, wherein the deformation zone is shown as FIG. 5. Lubricate represents lubricating oil, σ_{f} represents front tension, σ_{b} represents back tension, a dynamic rolling force is calculated by discretizing the deformation zone into 400 parts along the rolling direction and 200 parts along the width direction, and the Step 3 comprises the following steps:
Step 3.1: the dynamic contact arc length of deformation zone is calculated according to strip inlet and outlet thicknesses, the diameter and vertical vibration speed of the work roll. Under the consideration that the vertical vibration of work roll can cause changes in the deformation zone, the calculation formula of the dynamic contact arc length l_{d} is obtained as below:

$${l}_{d} = \{ \begin{matrix}\sqrt{{( R sin θ )}^{2} + R cos θ ( {y}_{in} - {y}_{out} ) - \frac{{( {y}_{in} - {y}_{out} )}^{2}}{4}} - R sin θ & {v}_{y} \geq 0 \\ \sqrt{{( R sin θ )}^{2} + R cos θ ( {y}_{in} - {y}_{out} ) - \frac{{( {y}_{in} - {y}_{out} )}^{2}}{4}} + R sin θ & {v}_{y} < 0\end{matrix} .$$

Wherein R represents the flattening radius of the work roll, in mm; yᵢₙ and yₒᵤₜ represent the strip inlet and outlet thicknesses, in mm; θ represents the variation of bite angle, in rad; and v_{y} represents the vertical vibration speed of the work roll and is positive in an upward direction, in m/s.

The flattening radius of the work roll is calculated according to the Hitchcock formula as below:

$$R = {R}_{0} ( 1 + 2 \sqrt{\frac{p}{{E}_{w} ( {y}_{in} - {y}_{out} )}} + 2 \frac{p}{{E}_{w} ( {y}_{in} - {y}_{out} )} ) .$$

Wherein, R₀ represents the initial radius of the work roll; E_{w} represents the elasticity modulus of the work roll, taking 2.1×10¹¹ Pa; and p represents the rolling force of unit length.
Step 3.2: The average deformation resistance of each micro element is calculated by using a deformation resistance model according to the strip material and thickness of each micro element.

In the embodiment, the grade of strip is Q195, and the average deformation resistance σₛ is calculated by the following formula:

$${σ}_{s} = ( A + B \cdot {ε}_{Σ} ) ( 1 - C \cdot {e}^{- D \cdot {ε}_{Σ}} ) .$$

Wherein ε_{Σ} represents the cumulative deformation,

$${ε}_{Σ} = \frac{2}{\sqrt{3}} \cdot ln ( \frac{{y}_{0}}{\overline{y}} ) ;$$

y₀ represents the hot-rolled incoming material thickness; y̅ represents the average thickness of rolling pass,

$$\overline{y} = \frac{{y}_{i n} + 2 {y}_{o u t}}{3} ;$$

the empirical values of coefficients are A=498 MPa, B=136 MPa, C=0.2 and D=5 respectively.
Step 3.3: friction stress distribution in the deformation zone is calculated.

The rolling interface is in a mixed lubrication state with boundary and hydrodynamic lubrication during high-speed rolling, the friction stress distribution τ in the deformation zone can be expressed as:

$$τ = {A}_{c} {τ}_{a} + ( 1 - {A}_{c} ) {τ}_{f} = {A}_{c} {k}_{s} + ( 1 - {A}_{c} ) η \frac{{v}_{s} - {v}_{r}}{{h}_{t}} .$$

Wherein τ represents the whole friction stress distribution in the deformation zone; τₐ represents the friction stress generated by rough contact; τ_{f} represents the friction stress generated by hydrodynamic lubrication; kₛ represents the shear strength of materials; η represents the viscosity of lubricating oil; vᵣ represents the rolling speed; vₛ represents the speed distribution of strip along the rolling direction; hₜ represents the average oil film thickness; A_{c} represents the actual contact area ratio.

According to the assumption of Gaussian roughness distribution, the actual contact area ratio A_{c} and average oil film thickness hₜ can be expressed as:

$${A}_{c} = {\int }_{h}^{∞} f ( δ ) d δ = \frac{16 - 35 Z + 35 {Z}^{3} - 21 {Z}^{5} + 5 {Z}^{7}}{32} .$$

$${h}_{t} = {{\int }_{- h}}^{∞} ( h + δ ) f ( δ ) d δ = \frac{3 {R}_{q}}{256} ( 35 + 158 Z + 140 {Z}^{2} - 70 {Z}^{4} + 28 {Z}^{6} - 5 {Z}^{8} ) .$$

Wherein Z=h/3R_{q} represents the dimensionless parameter; f(δ) represents the probability density function, which can be expressed as:

$$f ( δ ) = \{ \begin{matrix}\frac{35}{96 {R}_{q}} [ 1 - \frac{1}{9} {( \frac{δ}{{R}_{q}} )}^{2} & δ \leq 3 {R}_{q} \\ 0 & \vert δ \vert \geq 3 {R}_{q}\end{matrix} .$$

Wherein δ represents the roughness distribution, in μm; R_{q} represents the comprehensive surface roughness of strip and rolls, in μm.

The oil film thickness distribution h(x) in the deformation zone can be expressed by the following formula:

$$h ( x ) = \frac{{v}_{r} + {v}_{i n}}{{v}_{r} + {v}_{s}} {h}_{0} .$$

Wherein vᵢₙ represents the strip inlet speed, in m/s; h₀ represents the inlet oil film thickness, in mm, which can be determined by the following formula:

$${h}_{0} = \frac{3 {η}_{0} α R ( {v}_{i n} + {v}_{r} )}{{l}_{0} [ 1 - {e}^{- α ( {σ}_{s} - {σ}_{b} )} ]} .$$

Wherein η₀ represents the viscosity of lubricating oil under atmospheric pressure; α represents the viscosity pressure coefficient of Barus formula, in MPa⁻¹; l₀ represents the contact arc length when v_{y}=0.
Step 3.4: a force balance differential equation of the micro element in the deformation zone is established.

Dynamic rolling force is calculated by combining the force balance differential equation of micro elements and friction stress distribution in the deformation zone.

According to the force condition of micro elements, the force balance differential equation is as below:

$$\{ \begin{matrix}y \frac{dp}{dx} - {K}_{p} ( \frac{dy}{dx} - 2 \frac{{v}_{y}}{{v}_{s}} ) \pm 2 τ = 0 & {v}_{y} \geq 0 \\ y \frac{dp}{dx} - {K}_{p} ( \frac{dy}{dx} + 2 \frac{{v}_{y}}{{v}_{s}} ) \pm 2 τ = 0 & {v}_{y} < 0\end{matrix} .$$

Wherein Kₚ=1.1550, represents the deformation resistance of strip, in MPa; “+” represents the backward slip zone, and “−” represents the forward slip zone.
Step 3.5: the friction stress distribution obtained in the Step 3.3 is substituted into the force balance differential equation, and integrating is performed along the rolling and width directions to obtain the dynamic rolling force.
Step 4: according to the force relationship between the rolls and strip and calculated dynamic rolling force, a vertical vibration dynamic equation of the mill-strip system is established, and the roll displacement response is solved to predict the critical vibration speed of the six-high cold rolling mill, wherein the Step 4 comprises the following steps:
Step 4.1: a vertical vibration dynamic equation of the mill-strip system is established by analyzing the stress among the strip, rolls and mill housing according to the following equations:

$$M \ddot{x} + C \dot{x} + K x = F - {F}_{i w} - {F}_{b i} ,$$

$$M \ddot{x} + C \dot{x} + {K}_{z} x = M \ddot{x} + ( {β}_{1} M + {β}_{2} {K}_{z} ) \dot{x} + ( K + {K}_{i w} + {K}_{b i} ) x = F ,$$

$${β}_{1} = \frac{2 ( {ξ}_{1} {ω}_{2} - {ξ}_{2} {ω}_{1} )}{( {ω}_{2}^{2} - {ω}_{1}^{2} )} {ω}_{1} {ω}_{2} , {β}_{2} = \frac{2 ( {ξ}_{1} {ω}_{2} - {ξ}_{2} {ω}_{1} )}{( {ω}_{2}^{2} - {ω}_{1}^{2} )} .$$

Wherein x, \dot{x} and \ddot{x} respectively represent the displacement, speed and acceleration vectors of beam element nodes of the rolls; M represents the whole mass matrix of the six-high cold rolling mill; C represents the whole damping matrix of the six-high cold rolling mill; K_{z} represents the whole stiffness matrix of the six-high cold rolling mill; K represents the total stiffness matrix formed by combining beam element models of the backup roll, the intermediate roll and the work roll; K_{iw} represents the inter-roll contact stiffness matrix between the intermediate roll and the work roll; K_{bi} represents the inter-roll contact stiffness matrix between the backup roll and the intermediate roll; F_{iw} represents the contact force distribution between the work roll and the intermediate roll, F_{iw}=K_{iw}x; F_{bi} represents the contact force distribution between the intermediate roll and the backup roll, F_{bi}=K_{bi}x; F represents the rolling force distribution along width direction; β₁ and β₂ represent the proportional coefficients; ξ₁ and τ₂ represent the damping ratios; ω₁ and ω₂ represent the frequencies.
Step 4.2: the vertical vibration dynamic equation is solved by the Newmark-Beta method to obtain the displacement response curve of rolls at a specific speed. Under the set maximum calculation time tₘₐₓ, dynamics calculation at the next time continues when t≤tₘₐₓ, the dynamics calculation is stopped when t>tₘₐₓ, and when the amplitude of displacement response curve is constant, the corresponding speed is the critical vibration speed of the six-high cold rolling mill.

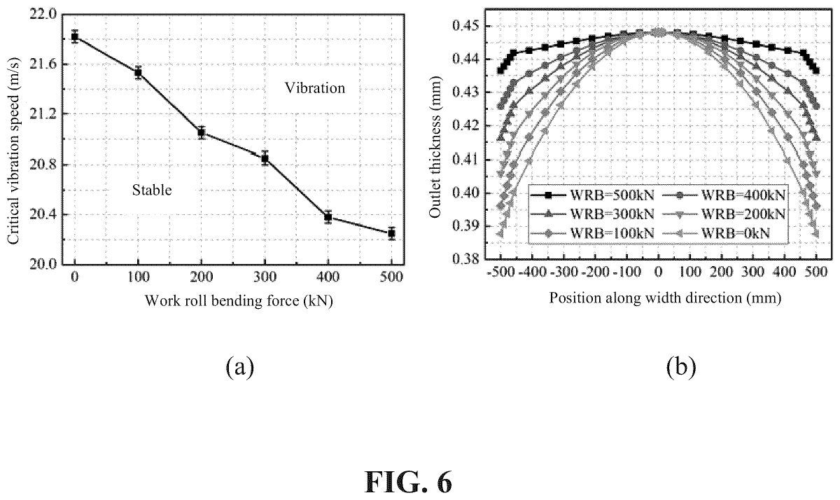

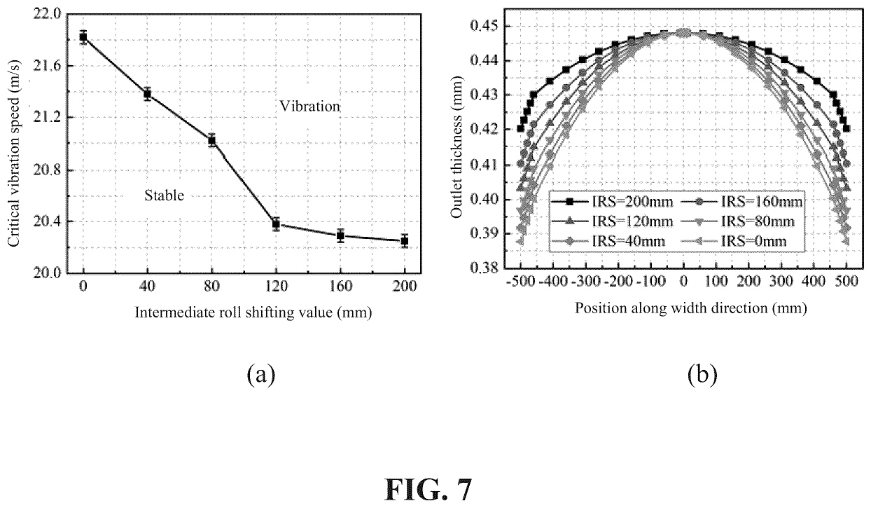

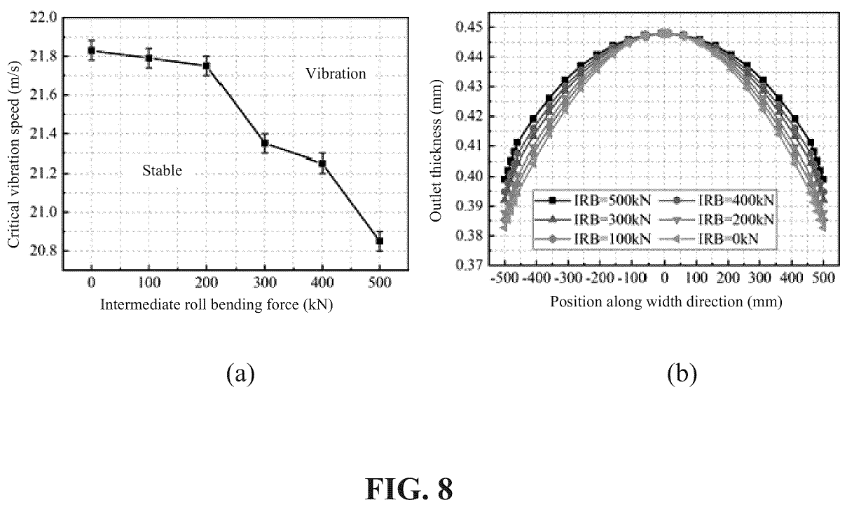

In actual production, the six-high cold rolling mill frequently vibrates in the 4th and 5th stand, so that in the embodiment, the critical vibration speed of 4th stand should be predicted. FIG. 6, FIG. 7 and FIG. 8 respectively show influence of work roll bending force, intermediate roll bending force and intermediate roll shifting value on the critical vibration speed of the six-high cold rolling mill, and the strip outlet profile at the corresponding critical vibration speed. When the rolling speed is higher than the critical vibration speed, the six-high cold rolling mill vibrates; and when the rolling speed is lower than the critical vibration speed, the six-high cold rolling mill is in the stable rolling state.

According to the prediction method for critical vibration speed of a six-high cold rolling mill based on a three-dimensional model, firstly, a three-dimensional six-high cold rolling mill model is constructed with improved Timoshenko beams by coupling a dynamic rolling force calculation model, calculation speed and precision are improved; secondly, by the method, not only influence of two-dimensional rolling parameters on the stability of the rolling process can be studied, but also influence of parameters along width direction, such as roll bending and shifting, on the critical rolling speed can be analyzed, and compared with other methods, using the method disclosed by the invention, the analysis parameters are more comprehensive and reasonable; furthermore, by adopting the method provided by the invention, the critical vibration speed of the six-high cold rolling mill can be predicted at the rolling schedule formulation stage, thereby providing theoretical support for the optimization of rolling parameters; and finally, based on vibration mechanism and simulation, the equipment damage or safety accidents caused by vibration of the six-high cold rolling mill can be avoided.

What is claimed is:

1. A prediction method for critical vibration speed of a six-high cold rolling mill based on a three-dimensional model, comprising the following steps:
Step 1: obtaining production process parameters in a period of time in an actual production of a tandem cold rolling production line;
Step 2: according to a finite element model and an inter-roll contact stiffness of each roll in the six-high cold rolling mill, establishing a whole stiffness matrix, a whole mass matrix and a whole damping matrix of the six-high cold rolling mill;
Step 3: discretizing a deformation zone into a number of parts along a rolling direction and a width direction direction, and calculating a dynamic rolling force;
Step 4: according to a force relationship between rolls and strip and the calculated dynamic rolling force, establishing a vertical vibration dynamic equation of a mill-strip system, and obtaining a roll displacement response to predict the critical vibration speed of the six-high cold rolling mill.

2. The prediction method of claim 1, wherein the production process parameters comprise structure parameters of the six-high rolling mill, rolling parameters, strip parameters and lubricating oil parameters,
wherein the structure parameters of the six-high cold rolling mill comprise a material, an elasticity modulus, a Poisson's ratio, a density, a roll body length and a roll body diameter, a roll neck length and a roll neck diameter and material, mass and size of a mill housing,
wherein the rolling parameters comprise front and back tensions between stands, a rolling speed of each rolling pass, a strip inlet speed of each rolling pass, strip inlet and outlet thicknesses of each rolling pass, a work roll bending force, an intermediate roll bending force and an intermediate roll shifting value, and
wherein the strip parameters and the lubricating oil parameters comprise a grade and a width of the strip, an incoming material thickness, and a viscosity and a viscosity pressure coefficient of lubricating oil.

3. The prediction method of claim 1, wherein the Step 2 comprises the following steps:
Step 2.1: establishing the finite element model of each roll in the six-high cold rolling mill;
Step 2.2: calculating the inter-roll contact stiffness of each roll; and
Step 2.3: according to the finite element model and the inter-roll contact stiffness of each roll, establishing the whole stiffness matrix, the whole mass matrix and the whole damping matrix of the six-high cold rolling mill.

4. The prediction method of claim 1, wherein the Step 3 comprises the following steps:
Step 3.1: calculating a dynamic contact arc length l_{d} of the deformation zone according to strip inlet and outlet thicknesses, a diameter and a vertical vibration speed of a work roll, by the following equation:
$${l}_{d} = \{ \begin{matrix}\sqrt{{( R sin θ )}^{2} + R cos θ ( {y}_{i n} - {y}_{out} ) - \frac{{( {y}_{i n} - {y}_{out} )}^{2}}{4}} - R sin θ & {v}_{y} \geq 0 \\ \sqrt{{( R sin θ )}^{2} + R cos θ ( {y}_{i n} - {y}_{out} ) - \frac{{( {y}_{i n} - {y}_{out} )}^{2}}{4}} + R sin θ & {v}_{y} < 0\end{matrix} ,$$
wherein R represents a flattening radius of the work roll; yᵢₙ and yₒᵤₜ represent the strip inlet and outlet thicknesses; θ represents a variation of a bite angle; and v_{y} represents the vertical vibration speed of the work roll and is positive in an upward direction;
Step 3.2: calculating an average deformation resistance of each micro element by using a deformation resistance model according to a strip material and a thickness of each micro element;
Step 3.3: calculating a friction stress distribution in the deformation zone;
Step 3.4: establishing a force balance differential equation of each micro element in the deformation zone; and
Step 3.5: substituting the friction stress distribution obtained in the Step 3.3 into the force balance differential equation, and performing integrating along the rolling direction and the width direction to obtain the dynamic rolling force.

5. The prediction method of claim 1, wherein the Step 4 comprises the following steps:
Step 4.1: establishing the vertical vibration dynamic equation of the mill-strip system according to the following equations:
$$M \ddot{x} + C \dot{x} + K x = F - {F}_{i w} - {F}_{b i} ,$$
$$M \ddot{x} + C \dot{x} + {K}_{z} x = M \ddot{x} + ( {β}_{1} M + {β}_{2} {K}_{z} ) \dot{x} + ( K + {K}_{i w} + {K}_{b i} ) x = F ,$$
$${β}_{1} = \frac{2 ( {ξ}_{1} {ω}_{2} - {ξ}_{2} {ω}_{1} )}{( {ω}_{2}^{2} - {ω}_{1}^{2} )} {ω}_{1} {ω}_{2} , {β}_{2} = \frac{2 ( {ξ}_{1} {ω}_{2} - {ξ}_{2} {ω}_{1} )}{( {ω}_{2}^{2} - {ω}_{1}^{2} )} .$$
wherein x, \dot{x} and \ddot{x} respectively represent displacement, speed and acceleration vectors of beam element nodes of the rolls; M represents the whole mass matrix of the six-high cold rolling mill; C represents the whole damping matrix of the six-high cold rolling mill; K_{z} represents the whole stiffness matrix of the six-high cold rolling mill; K represents a total stiffness matrix formed by combining beam element models of a backup roll, an intermediate roll and the work roll; K_{iw} represents an inter-roll contact stiffness matrix between the intermediate roll and the work roll; K_{bi} represents an inter-roll contact stiffness matrix between the backup roll and the intermediate roll; F_{iw} represents a contact force distribution between the work roll and the intermediate roll, F_{iw}=K_{iw}x; F_{bi} represents a contact force distribution between the intermediate roll and the backup roll, F_{bi}=K_{bi}x; F represents a rolling force distribution along the width direction; β₁ and β₂ represent proportional coefficients; ξ₁ and ξ₂ represent damping ratios; ω₁ and ω₂ represent frequencies; and
Step 4.2: solving the vertical vibration dynamic equation by a Newmark-Beta method to obtain a displacement response curve of the rolls at a specific speed, wherein when an amplitude of the displacement response curve is constant, a corresponding speed is the critical vibration speed of the six-high cold rolling mill.

6. The prediction method of claim 3, wherein the Step 2.1 comprises the following steps:
Step 2.1.1: simplifying each roll in the six-high cold rolling mill to beams and discretizing into a number of elements;
Step 2.1.2: determining a shape function expression of node displacement vectors of each element according to an interpolation function;
Step 2.1.3: deriving an element stiffness matrix by using a virtual work principle and performing assembling; and
Step 2.1.4: deriving an element mass matrix by using the virtual work principle and performing assembling.

7. The prediction method of claim 3, wherein the Step 2.3 comprises the following steps:
Step 2.3.1: obtaining stiffness coefficients of the six-high cold rolling mill by a pressing test, and stiffness coefficients of a mill housing are calculated by a finite element analysis software;
Step 2.3.2: determining stiffness coefficients of a backup roll in combination with the calculated inter-roll contact stiffness, and obtaining the whole stiffness matrix of the six-high cold rolling mill, according to the following equation:
$${K}_{z} = K + {K}_{i w} + {K}_{b i} ,$$
wherein K_{z} represents the whole stiffness matrix of the six-high cold rolling mill; K represents a total stiffness matrix formed by combining beam element models of the backup roll, an intermediate roll and a work roll; K_{iw} represents an inter-roll contact stiffness matrix between the intermediate roll and the work roll; K_{bi} represents an inter-roll contact stiffness matrix between the backup roll and the intermediate roll, according to the following equations:
$${K}_{iw} = {[ \begin{matrix}- {k}_{{n}_{1} {n}_{1}}^{1} & & & {k}_{{n}_{1} {n}_{3}}^{1} & & \\ & ⋱ & & & ⋱ & \\ & & - {k}_{{n}_{2} {n}_{2}}^{1} & & & {k}_{{n}_{2} {n}_{4}}^{1} \\ {k}_{{n}_{3} {n}_{1}}^{1} & & & - {k}_{{n}_{3} {n}_{3}}^{1} & & \\ & ⋱ & & & ⋱ & \\ & & {k}_{{n}_{4} {n}_{2}}^{1} & & & - {k}_{{n}_{4} {n}_{4}}^{1}\end{matrix} ]}_{2 n \times 2 n} ,$$
$${K}_{bi} = {[ \begin{matrix}- {k}_{{n}_{3} {n}_{3}}^{2} & & & {k}_{{n}_{3} {n}_{5}}^{2} & & \\ & ⋱ & & & ⋱ & \\ & & - {k}_{{n}_{4} {n}_{4}}^{2} & & & {k}_{{n}_{4} {n}_{6}}^{2} \\ {k}_{{n}_{5} {n}_{3}}^{2} & & & - {k}_{{n}_{5} {n}_{5}}^{2} & & \\ & ⋱ & & & ⋱ & \\ & & {k}_{{n}_{6} {n}_{6}}^{2} & & & - {k}_{{n}_{6} {n}_{6}}^{2}\end{matrix} ]}_{2 n \times 2 n} ,$$
wherein n=n_{w}+n+n_{b}, n₁-n₆ represent row and column numbers, and are selected according to the following conditions:
$$\begin{matrix}{n}_{1} = 1 ; {n}_{2} = 2 {n}_{w} - 1 ; {n}_{3} = 2 {n}_{w} + 1 ; {n}_{4} = 2 ( {n}_{w} + {n}_{i} ) - 1 \\ {n}_{5} = 2 ( {n}_{w} + {n}_{i} ) + 1 ; {n}_{6} = 2 ( {n}_{w} + {n}_{i} + {n}_{b} ) - 1\end{matrix} , if {n}_{s} = 0 ,$$
$$\begin{matrix}{n}_{1} = 2 {n}_{s} + 1 ; {n}_{2} = 2 {n}_{w} - 1 ; {n}_{3} = 2 {n}_{w} + 1 ; {n}_{4} = 2 ( {n}_{w} + {n}_{i} - {n}_{s} ) - 1 \\ {n}_{5} = 2 ( {n}_{w} + {n}_{t} + {n}_{s} ) + 1 ; {n}_{6} = 2 ( {n}_{w} + {n}_{i} + {n}_{b} ) - 1\end{matrix} , \\ if {n}_{s} > 0 ,$$
$$\begin{matrix}{n}_{1} = 1 ; {n}_{2} = 2 ( {n}_{w} - {n}_{s} ) - 1 ; {n}_{3} = 2 ( {n}_{w} + {n}_{s} ) + 1 ; {n}_{4} = 2 ( {n}_{w} + {n}_{t} ) - 1 \\ {n}_{5} = 2 ( {n}_{w} + {n}_{t} ) + 1 ; {n}_{6} = 2 ( {n}_{w} + {n}_{i} + {n}_{b} - {n}_{s} ) - 1\end{matrix} , \\ if {n}_{s} < 0 ,$$
wherein n_{w}, nᵢ and n_{b} respectively represent a number of nodes of the work roll, the intermediate roll and the backup roll; nₛ represents a number of nodes corresponding to an intermediate roll shifting value; and
Step 2.3.3: by using a Rayleigh damping formula, the whole stiffness and the whole mass matrix of the six-high cold rolling mill, obtaining the whole damping matrix of the six-high cold rolling mill.
